(19) United States
(12) Patent Application Publication
(10) Pub. No.: US 2014/0280375 A1
(43) Pub. Date: Sep. 18, 2014

(54) SYSTEMS AND METHODS FOR IMPLEMENTING DISTRIBUTED DATABASES USING MANY-CORE PROCESSORS

(71) Applicants: Ryan Rawson, San Francisco, CA (US); Alexander Newman, San Francisco, CA (US)

(72) Inventors: Ryan Rawson, San Francisco, CA (US); Alexander Newman, San Francisco, CA (US)

(21) Appl. No.: 14/209,454

(22) Filed: Mar. 13, 2014

Related U.S. Application Data
(60) Provisional application No. 61/794,716, filed on Mar. 15, 2013.

(51) Int. Cl. G06F 17/30

(52) U.S. Cl. CPC G06F 17/30289
USPC 707/803

(57) ABSTRACT

A distributed database, comprising a plurality of server racks, and one or more many-core processor servers in each of the plurality of server racks, wherein each of the one or more many-core processor servers comprises a many-core processor configured to store and access data on one or more solid state drives in the distributed database, where the one or more solid state drives are configured to enable retrieval of data through one or more text-searchable indexes. The one or more many-core processor servers are configured to communicate within the plurality of server racks via a network, and the data is configured as one or more tables distributed to the one or more many-core processor servers for storage in the one or more solid state drives.

### RELATED APPLICATIONS

The present application claims priority to U.S. Provisional Patent Application No. 61/794,716, filed Mar. 15, 2013, the disclosure and teaching of which are incorporated by reference herein.

### FIELD OF THE INVENTION

The present invention relates to distributed databases and more specifically to distributed databases implemented on servers constructed using many-core processors.

### BACKGROUND OF THE INVENTION

A multi-core processor is a single computing component with two or more independent actual central processing units called “cores”, which are units that read and execute program instructions. The incorporation of increasingly larger numbers of cores onto processors has led to the coining of the term “many-core processors” to describe processors including tens and/or hundreds of cores. Processors like the Tilera 64-core Tilera TILEPro 64 processor (Part No. TLR3-6480BG-9C) manufactured by Tilera, Corporation of San Jose, Calif. and the Epiphany-IV 64-core Microprocessor (Part No. E64G401) offered by Adapteva, Inc. of Lexington, Mass. offer new opportunities in high performance low power computing. In many instances, many-core processors can operate at comparatively lower clock speeds to state of the art multi-core processors. Accordingly, the processors can consume much less power at similar computational loads through parallelization.

The present invention aims to overcome the issue presented to many cloud vendors regarding the latest tech twins: the “cloud” and “big data,” namely the cloud's inefficient use of electricity and the costly bow wave it creates, which many cloud vendors have only started to recognize.

The Information Age—the epoch of rapidly searchable and retrievable data—became possible when data recorded on paper could be recorded instead in digital media, thanks to computers and their miniaturized off-spring of personal computers, laptops, cell phones, and smart phones. Each invention enhanced our ability to generate, search, and retrieve ever more prodigious quantities of data. Each allowed data to be stored in ever-smaller media with ever-larger storage capacities, where instantaneous searches generate additional data—the search results. When used to connect to the “cloud,” the remotely accessible, rapidly searchable macrocosm of interlinked bits of information retrievable almost the moment they are created became known as “big data.”

As with every new technological wave, customers have noticed features they interact with—ubiquitous connectivity to “clouds” of “big data” and the insights the extracted data reveal. The learning curve for using these technologies and getting the most from them distracts customers from asking or knowing much about the new tech's intricate, hidden innards. At most, there is a clue about the inner workings of these devices—our hands feel hot spots on smartphone, iPad, and laptop cases. Sometimes, after prolonged use, the heat intensity surprises us and reveals a design secret: these powerfully smart devices run on electricity, guzzle it, and waste it away as heat. It happens with every device that customers operate to access the “cloud.” It also happens in the “cloud,” but on a massive scale.

Most imagine the “cloud” as a big powerful computer or server. Imagine instead that there are multiple “clouds” and each operates millions of computer servers, each rack of servers an electric power guzzler that converts and expels it as heat. As computers draw more power, they create and expel a proportional amount of heat. For every kilowatt of electricity needed to operate a cloudbank of servers, an additional kilowatt is used to cool the heat generated from operation. The astronomical number of computers in a cloud makes the rooms and server “farms” that house them into intensely hot bodies. Machines, though, have heat limits, and above those limits, they become heat intolerant. Machines, like animal species, thrive in a thermal niche, not far above which they get sluggish and wear down, and abruptly succumb at their perish temperature. In the closed rooms of a cloud's server “farms,” the heat the servers expel, if not removed, wears them out or, if high enough, kills them.

Dissipated heat exceeds what fans can remove. Ambient air should be cooled. For the past 15 years, the power to cool and operate the datacenter has remained equivalent to the power used to power the servers within the datacenter. This near doubling of electricity costs that each hot “cloud” racks up is their greatest operating expense, and it dwarfs all other operating costs combined. Thus, the cloud's big problem is that the bigger the “big data” promises it makes to its corporate customers, the greater the computing capabilities and electricity consumption becomes. Soaring costs create a drag that cloud benefits cannot indefinitely overcome. The cloud's electricity consumption limits its profits, limits its advantageous scalability, and, if not curtailed, limits its future.

Solutions pursued, at present, try to squeeze efficiencies from incremental reductions in cooling requirements. That strategy has led to heat exchange “tradeoffs”: a cloud vendor sets the A/C thermostat high (above 90° F.), a temperature that needs less cooling and less electricity to maintain, but in exchange operation of the servers becomes increasingly difficult and stresses their components with thermal wear-and-tear by forcing many components to operate outside of their optimal thermal range. The “cloud” business model, driven by customer needs for round-the-clock operation of the cloud, absorbs and conceals the underlying waste of equipment and energy. Our solution reduces the heat exchange “tradeoff” and averts the waste of so much energy, equipment, and money.

The present invention focuses on avoiding wasteful solutions and figured out that the architecture of the dominant microprocessor chip designed the thermal problem into the cloud's servers. To explain, we need to simplify what's going on “under the hood” of these chips. The chips have an underlying limited core architecture that processes data in a way resembling an inefficient relay race; data processing proceeds in simultaneous multiples, racing through a few cores to complete its tasks and necessitating precise synchronization to avoid errors that force the tasks to be restarted. That architecture requires high clock speeds. It draws proportionately high quantities of electricity and wastes it in expelled heat. In short, for architecture reliant on a few cores to process data at high rates, it requires running at high clock speeds, and draw and waste great quantities of electric power.

An alternative chip architecture that has now become available avoids the “great race,” clock speed, and energy waste by substituting a multi-core (and, in the cloud, a massively multi-core) architecture. With many more cores available to do the processing work, each can work more slowly, draw less electricity, dissipate less heat, and need less cooling. The same heat equation that punishes the dominant limited core chips, necessitating a kilowatt of cooling for every kilowatt of operating electricity, thus doubling the energy cost, will reward the new multi-core chip, enabling kilowatts of reduced operating electricity to be matched by kilowatts of proportionately reduced cooling. There's just one “hitch”: the existing databases cannot run on the new multi-core chips. Designed to run on limited core chips, their structure is incompatible with multi-core chip architecture.

The present invention presents an elegant solution to that “hitch,” namely software designs that overcome the incompatibility and enable databases to run on new multi-core chip machines (as well as on the dominant limited core machines).

The present invention seeks to refine the design, develop the prototype, and produce commercial versions for operators of large clouds facing rising electrical costs. For the year 2011, 44% of data center operators reported that increasing energy costs would significantly impact their operations. Until operators and owners of “clouds” grasp the growing electrical cost problem and solve it, the technologies of “big data” and the “cloud” will exacerbate the problem because owners and operators plan to deploy an ever-larger profusion of inefficient, heat-expelling computers within their A/C-burdened server farms. Our innovative software will highlight their growing problem and provide them a handy, quickly deployable solution, giving the industry profit margins that previously eluded it.

The present invention is also preferably applicable to work for militaries that need to solve comparable problems at stateside installations detached from the grid where electricity needs to be conserved. Our software can also alleviate electricity shortages at forward operating bases downrange where scarce supplies of electricity can limit the use and advantages of advanced “big data” tech systems. For ground forces, these will be the new, increasingly critical logistics challenges and our software can solve the problem before it compromises capabilities and missions and causes unnecessary casualties. Moreover, our approach to software design and coding will help reduce the DoD's supply-chain risk from “full spectrum” adversaries because our company will build products from scratch at domestic software labs we create and keep under our exclusive control.

### SUMMARY OF THE INVENTION

The present invention comprises a distributed database, comprising a plurality of server racks, and one or more many-core processor servers in each of the plurality of server racks, wherein each of the one or more many-core processor servers comprises a many-core processor configured to store and access data on one or more solid state drives in the distributed database, where the one or more solid state drives are configured to enable rapid, low power retrieval of data. The one or more many-core processor servers are configured to communicate within the plurality of server racks via a network, and the data is configured as one or more tables across one or more nodes of the distributed database which is distributed to the one or more many-core processor servers for storage in the one or more solid state drives.

### BRIEF DESCRIPTION OF THE DRAWINGS

FIG. 1 is a conceptual illustration of a many-core processor showing an integrated circuit and interconnected tiles;

FIG. 2 is a more detailed illustration of an individual tile, as shown in FIG. 1, incorporating a processor and its associated switch;

FIG. 3 discloses the circuitry of a switch which is one component of an individual tile as shown in FIG. 2;

FIG. 4 is one embodiment of the present invention showing a distributed database implemented using many-core processor servers;

FIG. 5 is an example of three many-core processer servers as would be utilized in one embodiment of the present invention;

FIG. 6 illustrates a storage stack of a single node within a distributed database as would be utilized in the present invention;

FIG. 7 illustrates a write path that can be utilized within a database implemented using one or more many-core processer servers in the present invention;

FIG. 8 discloses a process for managing editing of tablets for use in the present invention;

FIG. 9A discloses a specific process for rapid write ahead log fail over for use in the present invention;

FIG. 9B is an alternate embodiment of the process depicted in FIG. 9A;

FIG. 9C discloses a process for performing rapid recovery in response to node failure as can be utilized by the present invention;

FIG. 10 illustrates a process for executing a database query by parsing the database query to create a Kahn Processing Network, as performed by the present invention;

FIG. 11 discloses a process for performing splits in a spatial index within a distributed database, as utilized by one embodiment of the present invention; and

FIG. 12 discloses a top level transaction story which may be utilized by one embodiment of the present invention.

### DETAILED DESCRIPTION OF THE INVENTION

Description will now be given of the invention with reference to the attached FIGS. 1-12. It should be understood that these figures are exemplary in nature and in no way serve to limit the scope of the invention as the invention will be defined by the claims, as interpreted by the Courts in an issued US patent.

A conceptual illustration of a many-core processor currently in existence is illustrated in FIG. 1, which shows an integrated circuit 100 (or “chip”) includes an array 101 of interconnected tiles 102. Each of the tiles 102 includes a processor (or “processor core”) and a switch that forwards data from other tiles to the processor and to switches of other tiles over data paths 104. In each tile, the switch is coupled to the processor so that data can be sent to or received from processors of other tiles over the communication fabric formed by the switches and data paths. The integrated circuit 100 includes other on-chip circuitry such as input/output (I/O) interface circuitry to couple data in and out of the circuit 100, and clock distribution circuitry to provide clock signals to the processors of the tiles. The example of the integrated circuit 100 shown in FIG. 1 includes a two-dimensional array 101 of rectangular tiles with data paths 104 between neighboring tiles to form a mesh network. The data path 104 between any two tiles can include multiple “wires” (e.g., serial, parallel or fixed serial and parallel signal paths on the IC 100) to support parallel channels in each direction. Optionally, specific subsets of wires between the tiles can be dedicated to different mesh networks that can operate independently.

The data paths 104 from one or more tiles at the edge of the network can be coupled out of the array of tiles 101 (e.g., over I/O pins) to an on-chip device 108A, an off-chip device 108B, or a communication channel interface 108C, for example. Multiple wires of one or more parallel channels can be multiplexed down to a fewer number of pins or to a serial channel interface. For example, the wires for one or more channels can be multiplexed onto a high-speed serial link (e.g., SerDes, SPIE4-2, or SPIE5) or a memory controller interface (e.g., a memory controller for DDR, QDR SRAM, or Dynamic RAM). The memory controller can be implemented, for example, off-chip or in logic blocks within a tile or on the periphery of the integrated circuit 100.

The tiles in a many-core processor can each have the same structure and functionality. Alternatively there can be multiple “tile types” each having different structure and/or functionality. For example, tiles that couple data off of the integrated circuit 100 can include additional circuitry for I/O functions.

A more detailed illustration of an individual tile of the prior art incorporating a processor and its associated switch is shown in FIG. 2. The tile 102 includes a processor 200, a switch 220, and sets of incoming wires 104A and outgoing wires 104B that form the data paths 104 for communicating with neighboring tiles. The processor 200 includes a program counter 202, an instruction memory 204, a data memory 206, and a pipeline 208. Either or both of the instruction memory 204 and data memory 206 can be configured to operate as a cache for off-chip memory. The processor 200 can use any of a variety of pipelined architectures. The pipeline 208 includes pipeline registers, functional units such as one or more arithmetic logic units (ALUs), and temporary storage such as a register file. The stages in the pipeline 208 can include, for example, instruction fetch and decode stages, a register fetch stage, instruction execution stages, and a write-back stage. Whether the pipeline 208 includes a single ALU or multiple ALUs, an ALU can be “split” to perform multiple operations in parallel. For example, if the ALU is a 32-bit ALU it can be split to be used as four 8-bit ALUs or two 16-bit ALUs. Processors 200 in many-core processors can include other types of functional units such as a multiply accumulate unit, and/or a vector unit.

The switch 220 includes input buffers 222 for temporarily storing data arriving over incoming wires 104A, and switching circuitry 224 (e.g., a crossbar fabric) for forwarding data to outgoing wires 104B or the processor 200. The input buffering provides pipelined data channels in which data traverses a path 104 from one tile to a neighboring tile in predetermined number of clock cycles (e.g., a single clock cycle). This pipelined data transport enables the integrated circuit 100 to be scaled to a large number of tiles without needing to limit the clock rate to account for effects due to wire lengths such as propagation delay or capacitance. (Alternatively, the buffering could be at the output of the switching circuitry 224 instead of, or in addition to, the input.)

Continuing to refer to the tile that is part of a many-core processor shown in FIG. 2, a tile 102 controls operation of a switch 220 using either the processor 200, or a separate switch processor dedicated to controlling the switching circuitry 224. Separating the control of the processor 200 and the switch 220 allows the processor 200 to take arbitrary data dependent branches without disturbing the routing of independent messages passing through the switch 220.

In some implementations, the switch 220 includes a switch processor that receives a stream of switch instructions for determining which input and output ports of the switching circuitry to connect in any given cycle. For example, the switch instruction includes a segment or “sub-instruction” for each output port indicating to which input port it should be connected. In some implementations, the processor 200 receives a stream of compound instructions with a first instruction for execution in the pipeline 208 and a second instruction for controlling the switching circuitry 224.

The switch instructions enable efficient communication among the tiles for communication patterns that are known at compile time. This type of routing is called “static routing.” An example of data that would typically use static routing is operands of an instruction to be executed on a neighboring processor.

The switch 220 also provides a form of routing called “dynamic routing” for communication patterns that are not necessarily known at compile time. In dynamic routing, circuitry in the switch 220 determines which input and output ports to connect based on the data being dynamically routed (for example, in header information). A tile can send a message to any other tile by generating the appropriate address information in the message header. The tiles along the route between the source and destination tiles use a predetermined routing approach (e.g., shortest Manhattan Routing). The number of hops along a route is deterministic but the latency depends on the congestion at each tile along the route. Examples of data traffic that would typically use dynamic routing are memory access traffic (e.g., to handle a cache miss) or interrupt messages.

The dynamic network messages can use fixed length messages, or variable length messages whose length is indicated in the header information. Alternatively, a predetermined tag can indicate the end of a variable length message. Variable length messages reduce fragmentation.

The switch 220 can include dedicated circuitry for implementing each of these static and dynamic routing approaches. For example, each tile has a set of data paths, buffers, and switching circuitry for static routing, forming a “static network” for the tiles; and each tile has a set of data paths, buffers, and switching circuitry for dynamic routing, forming a “dynamic network” for the tiles. In this way, the static and dynamic networks can operate independently. A switch for the static network is called a “static switch”; and a switch for the dynamic network is called a “dynamic switch.” There can also be multiple static networks and multiple dynamic networks operating independently. For example, one of the dynamic networks can be reserved as a memory network for handling traffic between tile memories, and to/from on-chip or off-chip memories. Another network may be reserved for data associated with a “supervisory state” in which certain actions or resources area reserved for a supervisor entity.

Referring to FIG. 3, prior art switching circuitry 224 preferably includes five multiplexers 300N, 300S, 300E, 300W, and 300P for coupling to the north tile, south tile, east tile, west tile, and local processor 200, respectively. Five pairs of input and output ports 302N, 302S, 302E, 302W, 302P are connected by parallel data buses to one side of the corresponding multiplexer. The other side of each multiplexer is connected to the other multiplexers over a switch fabric 310. In alternative implementations, the switching circuitry 224 additionally couples data to and from the four diagonally adjacent tiles having a total of 9 pairs of input/output ports. Each of the input and output ports is a parallel port that is wide enough (e.g., 32 bits wide) to couple a data word between the multiplexer data bus and the incoming or outgoing wires 104A and 104B or processor coupling wires 230.

A switch control module 304 selects which input port and output port are connected in a given cycle. The routing performed by the switch control module 304 depends on whether the switching circuitry 224 is part of the dynamic network or static network. For the dynamic network, the switch control module 304 includes circuitry for determining which input and output ports should be connected based on header information in the incoming data.

Although specific server and many-core processor architectures are shown with reference to FIGS. 1-3, there are a variety of server architectures that can be utilized that incorporate many-core processors.

Turning now to the drawings, systems and methods for implementing a distributed database on one or more many-core processors in accordance with embodiments of the invention are illustrated. In several embodiments, many-core processor servers including solid state drives (SSDs) are used to build a distributed database system. In a variety of embodiments, many-core processor servers include mechanical hard disk drives and/or drives constructed from volatile random access memory (RAM) coupled to a power source to enable the volatile RAM to store data in the event of a power failure with respect to the many-core processor server. Many-core processors can achieve very high levels of power efficiency as can SSDs, which mainly consume power during page-writes. Accordingly, many-core processor servers can be utilized to construct extremely power efficient databases and/or scalable distributed databases. In a distributed database, each many-core processor server can be considered to be a single node within a distributed database. In many embodiments, a table of data is partitioned into tablets that are divided across the nodes in the distributed database. Processes in accordance with embodiments of the invention can then be utilized to modify and query the tables in the distributed database in a computational, SSD access, and energy efficient manner.

In several embodiments, the distributed database is architected so that tables are accessed via a client application that interacts with a master many-core processor server. Instructions can be provided to the master many-core processor server to modify the table and/or retrieve information stored within the table in response to a search query. With respect to write applications, a node based abstraction can be utilized with respect to individual many-core processor servers in which the many-core processor servers behave in a manner not unlike a conventional server. In read applications, the concurrency inherent within many-core processors can be exploited by executing queries in a way that exploits distributed control and distributed memory. Distributed control means that the individual components on a platform can proceed autonomously in time without much interference from other components. Distributed memory means that the exchange of data is contained in the communication structure between individual components and not pooled in a large global memory common to the individual components.

Distributed database systems in accordance with many embodiments of the invention exploit the concurrency available through the use of many-core processors to parse queries into Kahn Processing Network (KPN) processes that can be mapped to specific processing cores within the nodes of the distributed database. A KPN is a message-passing model that yields provably deterministic programs (i.e. programs that yield always the same output given the same input, regardless of the order in which individual processes are scheduled). A KPN has a simple representation in the form of a directed graph with processes as nodes and communication channels at edges. Therefore, the structure of a KPN corresponds well with the processing tiles and high performance mesh within a many-core processor. The specifics of Kahn Processing Networks and the manner in which a statement in a query language can be parsed into a Kahn Processing Network that can be scheduled and executed on one or more many-core processors in accordance with an embodiment of the invention is discussed further below.

In several embodiments, the distributed database uses a variety of indexes to facilitate the recovery of data. In a number of embodiments, freeform text strings in one or more columns within a table are indexed to create a keyword index. In certain embodiments, a multi-dimensional index is overlaid on top of the one dimensional key-value index maintained by the distributed database to enable efficient real-time processing of multi-dimensional range and nearest neighbor queries. The use of various indexes to retrieve data stored in a distributed database in accordance with embodiments of the invention is discussed further below.

In several embodiments, the many-core processor servers utilize SSDs and tables of data within the distributed server are stored in a manner that preserves the useful lifetime of the SSDs. The useful lifetime of storage devices like SSDs that are constructed using non-volatile memory technologies, such as NAND Flash memory, that utilize page-mode accesses is typically specified in terms of the number of times to which a page in the SSD can be written. Accordingly, frequent page writes to a SSD can significantly shorten the useful lifetime of the SSD. In several embodiments, data is stored within the distributed database using a technique that exploits the random access capabilities of a SSD and achieves modifications of the SSD in ways that avoid frequent overwriting of data. Accordingly, distributed databases in accordance with many embodiments of the invention leave data stored in place within the SSDs within the distributed database and utilize indexes that can sort the data in order. In many embodiments, the data within a table is indexed and stored using a Log-Structured Merge tree (LSM-tree). A Log-Structured Merge-tree (LSM-tree) is a data structure designed to provide low-cost indexing for a file experiencing a high rate of record inserts (and deletes) over an extended period. The LSM-tree uses a process that defers and batches index changes, cascading the changes from dynamic memory through to a SSD and/or hard disk drive (HDD) in an efficient manner reminiscent of a merge sort. In any other embodiments, any of a variety of data structures that can be maintained using a number of page writes that preserves the useful lifetime of SSDs can be utilized to store and/or index stored data in accordance with embodiments of the invention including, but not limited to, using B+-trees to store data. In several embodiments, an advantage of using LSM-trees to store data is that many-core processor servers can be constructed that enable storage of tablets without the computational overhead of a file system. The lack of a file system means that an incremental power saving is achieved every time a page access occurs. Although, in many embodiments, many-core processor servers utilized in distributed databases in accordance with embodiments of the invention utilize file systems.

Failure is the norm when running large-scale distributed databases. Machine failures, per-node network partitions, per-rack network failures, and rack switch reboots are all possible causes of failure. The storage of ephemeral data is inherent to LSM-trees. Although storing ephemeral data and performing a batch page-write to an SSD is efficient and preserves the useful life of the SSDs, a risk is present that the ephemeral data will be lost in the event of a node failure. In many embodiments, a many-core processor server maintains a Write Ahead Log (WAL) with respect to the edits performed to one or more tablets that are served by the many-core processor server. WAL files ultimately serve as a protection measure that can be utilized to recover updates that would otherwise be lost after a tablet server crash. In several embodiments, fast failure recovery is achieved by utilizing distributed log splitting and a consistent distributed consensus process. Other journaling techniques can be utilized as appropriate to the requirements of specific applications in accordance with embodiments of the invention.

Distributed databases that can be implemented using many-core processor servers in accordance with embodiments of the invention are discussed further below.

Distributed Database Systems Implemented Using Many-Core Processor Servers

A distributed database implemented using many-core processor servers in accordance with an embodiment of the invention is illustrated in FIG. 4. In the illustrated embodiment, the distributed database 400 includes a number of server racks 402 that each contain one or more many-core processor servers (404, 406, and 408) that communicate via high performance backplanes within server racks and via a high performance network 410 between server racks. Three many-core processer servers (404, 406, and 408) in accordance with embodiments of the invention are illustrated in FIG. 5. The many-core processor servers (404, 406, and 408) each include a many-core processor 500 configured to access data within an SSD 502. The many-core processors 500 in the servers (404, 406, and 408) can communicate via a high performance backplane 504 and/or via a network. Many many-core processors incorporate a high speed serial link and a network controller on chip, facilitating rapid and efficient transfer of data between nodes in a distributed database implemented in accordance with embodiments of the invention.

Many-core processor servers (404, 406, and 408) can be constructed that are configured to store data within the distributed database system 400 on solid state drives (SSDs) enabling rapid, low power retrieval of data. In many embodiments, the distributed database 400 stores tables of data elements (values) that are organized using a model of columns (which are identified by their name) and rows. The tables are stored across the nodes in the distributed database by breaking the tables into tablets that are distributed to individual many-core processor servers (404, 406, and 408) for storage in their SSDs. In many embodiments, a tablet can be stored across multiple nodes and leases used to grant responsibility for the tablet to a single node. In this way, replicated tablets can be utilized during node failure to replay the WAL of a failed node to recover lost data. The data can be indexed and the indexes used for editing and retrieval of data. Various indexes that can be utilized to access data values within tables stored in distributed databases in accordance with embodiments of the invention are discussed further below.

In several embodiments, the many-core processor servers in the distributed database table is hosted and managed by sets of many-core processor servers which can fall into one of three categories:

1. One active master many-core processor server 404;

2. One or more backup many-core processor servers 406; and

3. Multiple region many-core processor servers 408.

As is discussed further below, a client application can be utilized to communicate with an active master many-core processor server to edit and query the distributed database. As noted above, the useful life of the SSDs of the nodes within the distributed database can be preserved by utilizing a LSM-tree to write data to the SSD. In several embodiments that are particularly optimized for low power performance, the LSM-tree is used to write blocks of data directly to the SSD without the overhead of a file system. In many embodiments, however, a many-core processor server incorporates a file system. WALs can be maintained by each node in order to be able to rebuild tablets served by a node in the event of the node's failure. In several embodiments, fast failure recovery is achieved utilizing the WALs of failed region many-core processor servers by utilizing distributed log splitting and a consistent distributed consensus process. In a number of embodiments, the distributed database includes a central lock server 410 that plays a role in the distributed log splitting and consistent distributed consensus processes. In a number of embodiments, the central lock server can be part of a centralized service for maintaining configuration information, naming, providing distributed synchronization, and providing group services. One such service is called Apache Zookeeper. In other embodiments, any of a variety of server implementations can be utilized to implement a central lock server as appropriate to the requirements of a specific application.

In several embodiments, the active master many-core processor server compiles a query statement provided in a query language such as, but not limited to, SQL into a physical Kahn Processing Network that can be overlaid on the cores of the region many-core processor servers based upon the proximity of the cores to data (i.e. specific tablets stored in SSDs). In several embodiments, processes for retrieving data in response to search queries leverage additional indexes. In many embodiments, keywords within text strings are indexed to provide full text search capabilities within a tablet. In several embodiments, a multi-dimensional index is overlaid on top of the one dimensional key-value index maintained by the distributed database to enable efficient real-time processing of multi-dimensional range and nearest neighbor queries. In other embodiments, any of a variety of indexes appropriate to the requirements of specific applications can be utilized.

Although specific architectures for distributed database systems are described above, any of a variety of architectures can be utilized to implement low powered databases and low powered distributed databases utilizing low power many-core processors and SSDs as appropriate to the requirements of specific applications in accordance with embodiments of the invention. Processes that can be utilized to write data to a distributed database and to query a distributed database in accordance with embodiments of the invention are discussed further below.

Data Storage within Nodes in a Distributed Database

Tables of data within a distributed database in accordance with embodiments of the invention can be broken into tablets and allocated to individual nodes within a distributed database. The tablets can be stored within the SSDs and indexes used to edit and retrieve data values from the tables. The storage stack of a single node within a distributed database in accordance with an embodiment of the invention is illustrated in FIG. 6. The storage stack 600 includes non-volatile storage in the form of a SSD 602 and/or a HDD 604. The writing of blocks of data to the SSD 602 and/or HDD 604 is managed by a raw block engine 606, which can be abstracted by a disk management and placement 608 process. A variety of indexes can be utilized to index data within the SSD 602 and/or the HDD 604. In the illustrated embodiment, an LSM-tree is utilized to store and index pages of data stored within the SSD 602. As is discussed further bellow, the random access capabilities of the SSD enable rows to be written to a tablet in any order and then accessed in an ordered manner using a sorted index. In the illustrated embodiment, an LSM-tree process 610 manages the storage of ephemeral data in memory and the flushing of the ephemeral data to the SSD 602. A WAL process 612 can be utilized to build a WAL for failure recovery. Additional indexes can also be generated to assist with the querying of data. In the illustrated embodiment, a keyword index is provided to provide the ability to locate specific keywords within freeform text stored within a tablet and/or locate rows based upon relevancy to specific keywords. As is discussed further below, a multi-dimensional index can be overlaid on the one dimensional index maintained by the LSM-tree to enable efficient real-time processing of multi-dimensional range and nearest neighbor queries.

The manner in which the data in the SSD is edited and accessed can be controlled by a distributed transaction engine 616, which provides transactional resources to a transaction manager such as (but not limited to) a master many-core processor server. As can readily be appreciated, the raw block engine 606, the disk management and placement 608, the LSM-tree application 610, the WAL application 612, additional indexing processes 614, and distributed transaction engine are all applications that can execute on a many-core processor in accordance with embodiments of the invention.

Although specific storage stacks that can be utilized to edit and retrieve data from one or more tablets stored in an SSD using a many-core processor are described above with respect to FIG. 6, any of a variety of storage stacks can be utilized in accordance with embodiments of the invention. Processes for storing and editing data in accordance with embodiments of the invention are discussed further below.

Storing Data Using Log-Structured Merge Trees

Distributed databases in accordance with many embodiments of the invention use LSM-trees to store data. A LSM-tree is a data structure designed to provide low-cost indexing for data experiencing a high rate of record inserts (and deletes) over an extended period. The LSM-tree uses a process that defers and batches index changes, cascading the changes from a memory-based component through one or more disk components in an efficient manner reminiscent of a merge sort. During this process all index values are continuously accessible to retrievals (aside from very short locking periods), either through dynamic memory or the SSD. The process can greatly reduce page writes to a SSD compared to a traditional access method such as a B+-tree. The LSM—tree approach can also be generalized to operations other than insert and delete. However, indexed finds requiring immediate response can lose I/O efficiency in some cases, so the LSM-tree can be most useful in applications where index inserts are more common than finds that retrieve the entries. In several embodiments, multiple indexes are provided and the index that provides the best performance with respect to a specific find request can be utilized. Various additional indexes that can be utilized in distributed databases as appropriate to the requirements of specific applications in accordance with embodiments of the invention are discussed further below.

An LSM-tree is composed of two or more tree-like component data structures. In many embodiments, the LSM tree indexes rows in tablets. A two component LSM-tree has a smaller component, which is entirely memory resident, which can be referred to as the dynamic memory tree, and a larger component which is resident on the SSD, known as the SSD tree. Although the SSD tree is resident in the SSD, frequently referenced page nodes in the SSD can remain in memory buffers within a many-core processing node, so that popular high level directory nodes of the SSD tree are reliably memory resident.

For each new row generated in a table, a log record to recover this insert is first written to the WAL. The index entry for the row is then inserted into the dynamic memory tree, after which it will in time migrate out to the SSD tree on disk; any search for an index entry will look first in dynamic memory tree and then in SSD tree. There is a certain amount of latency before entries in the dynamic memory tree migrate out to the SSD tree, implying a need for recovery of index entries that are not committed to the SSD prior to a crash or other failure. As noted above, journaling techniques, including WLAs, are used to reconstruct the lost content of the dynamic memory tree in the event of node failure. A write path that can be utilized to add a line to memory (memstore) to update a dynamic memory tree and to ultimately flush the additions to a SSD tree in the SSD in accordance with embodiments of the invention are discussed further below.

Write Path

The term “write path” describes the manner in which a distributed database in accordance with embodiments of the invention edits a tablet (i.e. performs put or delete operations). A write path that can be utilized within a database implemented using one or more many-core processer servers in accordance with an embodiment of the invention is illustrated in FIG. 7. The write path begins at a client application 700 that provides an appropriate command to a master many-core processor server, which generates a command to an appropriate region many-core processor server 702, and ends when data is written to a SSD 704 within the region many-core processor server 702. Included in the write path are processes that can prevent data loss in the event of a many-core processor server failure.

In a number of embodiments, each region many-core processor server 702 handles one or more tablets. Because region many-core processor servers are the only servers that serve tablet data, a master many-core processor server crash typically cannot cause data loss. In several embodiments, a client application 700 can update a table by invoking put or delete commands. When a client application requests a change, the request is routed to a region many-core processor server 702 or the client application can cache the changes in the client side, and flush these changes to region many-core processor servers in a batch.

Each row key belongs to a specific tablet, which is served by a region many-core processor server 702. Thanks to the use of LSM-trees to index the tablet rows stored within the SSD 704 of a region many-core processor server 702, the row key is sorted, and it can be easy to determine which region many-core processor server manages which key. A change request is for a specific row. Based on the key (put or delete), a client application 700 can locate the appropriate region many-core processor server 702. In certain embodiments, the client application 700 locates the address of the region many-core processor server 702 hosting the root region of a table from a distributed configuration service such as, but not limited to, an Apache ZooKeeper ensemble. Using the root region, the region many-core processor server that serves the requested tablet within the table can be located. This is a three-step process. Therefore, the region location can be cached to avoid these operations.

After the request is received by the region many-core processor server that serves the relevant tablet, the change is not written to the LSM-tree immediately because the data in the tablet can be sorted by the row key to allow efficient searching for random rows when reading data. Accordingly, data is written to a location in dynamic memory 706 (memstore), which acts as cache until sufficient data to perform a page-write is accumulated, at which point it is flushed into the SSD. Ephemeral data in dynamic memory 706 can be stored in the same manner as permanent data in the SSD. When the dynamic memory 706 accumulates enough data, the entire sorted set is written to the SSD. Because the non-volatile memory in SSDs typically supports page writes, writing entire pages of data to the SSD in one write task can significantly increase the useful lifetime and the performance of the SSD. To prevent this similar problem with WALs which could potentially cause over-writes, batch writes can pause at interval increments of milliseconds to write a bunch of data at one time, or flush intervals can reduce the number of partial page writes. Although caching data to dynamic memory 706 is efficient, it also introduces an element of risk. Information stored in dynamic memory 706 is ephemeral, so if the system fails, the data in the dynamic memory will be lost. Processes for using WAL logs to mitigate the risk of data loss during node failure in accordance with embodiments of the invention are discussed below with reference to the write path illustrated in FIG. 7.

Write Ahead Log

To help mitigate the risk of data loss in the event of region many-core processor server failure, a region many-core processor server 702 can save updates in a WAL 708 before writing information to dynamic memory 706 (i.e. memstore). In this way, if a region many-core processor server 702 fails, information that was stored in that server's dynamic memory 706 can be recovered from its WAL 708.

The data in a WAL 708 is organized differently from the LSM-tree. A WAL can contain a list of edits, with one edit representing a single put or delete. The edit can include information about the change and the tablet to which the change applies. Edits are written chronologically, so, for persistence, additions are appended to the end of the WAL that is stored in the SSD.

As WALs 708 grow, they can be closed and a new, active WAL file created to accept additional edits. This is can be referred to as “rolling” the WAL. Once a WAL is rolled, no additional changes are made to the old WAL. Constraining the size of a WAL 708 can facilitate efficient file replay if a recovery is required. This is especially important during replay of a tablet's WAL file because while a file is being replayed, the tablet is not available. The intent is to eventually write all changes from each WAL 708 to SSD. After this is done, the WAL 708 can be archived and can eventually be deleted. A WAL ultimately serves as a protection measure, and a WAL is typically only required to recover updates that would otherwise be lost after a region many-core processor server 702 crash.

A tablet many-core processor server 702 can serve many tablets, but may not have a WAL for each tablet. Instead, one active WAL can be shared among all the tablets served by the region many-core processor server. Because a WAL is rolled periodically, one region many-core processor server 702 may have many WAL versions. However, there is only one active WAL for a given tablet at any given time.

In several embodiments, each edit in the WAL has a unique sequence ID. In many embodiments, the sequence ID increases to preserve the order of edits. Whenever a WAL is rolled, the next sequence ID and the old WLA name are put in an in-memory map. This information is used to track the maximum sequence ID of each WAL so that a simple determination can be made concerning whether the WAL can be archived at a later time when the dynamic memory portion of an LSM-tree is flushed to the SSD.

Edits and their sequence IDs are typically unique within a region. Any time an edit is added to the WAL log, the edit's sequence ID is also recorded as the last sequence ID written. When the portion of the LSM-tree stored in dynamic memory 706 is flushed to the SSD 704, the last sequence ID written for this region is cleared. If the last sequence ID written to SSD is the same as the maximum sequence ID of a WAL 708, it can be concluded that all edits in a WAL for the region have been written to the SSD. If all edits for all regions in a WAL 708 have been written to the SSD 704, then no splitting or replaying is necessary, and the WAL can be archived.

In several embodiments, WAL file rolling and dynamic memory flush are two separate actions, and occur together. However, time-consuming recoveries can be avoided by limiting the number of WAL versions per region many-core processor server in case of a server failure. Therefore, when a WAL is rolled, the many-core processor server checks whether the number of WAL versions exceeds a predetermined threshold, and determines what tablets should be flushed so that some WAL versions can be archived.

A process for managing editing of tablets in accordance with embodiments of the invention is illustrated in FIG. 8. The process 800 includes receiving (801) an instruction to edit to a tablet, and writing (802) the type of edit, a sequence ID and a tablet ID (where the WAL relates to more than one tablet) to a WAL. The sequence ID can then be increased (804). A determination (806) is made concerning whether the size of the WAL exceeds a predetermined limit necessitating the rolling (808) of the WAL file. The edit is then saved (810) to the portion of the LSM-tree structure stored in dynamic memory and a determination (812) made concerning whether to flush the ephemeral data stored in dynamic memory into the SSD. As can readily be appreciated, any of a variety of criterion can be utilized to determine whether to proceed with flushing (814) the ephemeral data into the SSD.

Although specific write paths and processes for editing tablets stored within a distributed database are described above, any of a variety of techniques can be utilized to manage the migration of ephemeral data from dynamic memory into an SSD while providing failure recovery capabilities in accordance with embodiments of the invention. Failure recovery using WALs in accordance with embodiments of the invention is discussed further below.

Rapid Write Ahead Log Fail Over

As noted above, tables within distributed databases in accordance with embodiments of the invention are broken into tablets that are distributed across nodes within the distributed database. In a number of embodiments, leases are used to identify the nodes that have responsibility for different portions of the table. In the event of node failure, lease revocation is performed and ephemeral data lost during node failure can be rebuilt by another node using a replica of the tablets committed to SSD by the failed nodes and the WAL of the failed node(s). Upon restarting the nodes and/or granting leases to tablets served by the failed node(s) to alternative clusters, the tablets ideally should be updated using the WALs of the failed nodes before the nodes are started. In several embodiments, the process of rebuilding the portions of a table that were stored as ephemeral data and lost at the time of failure can be accelerated by using a central lock server to coordinate distributed log splitting to split the WALs of impacted nodes and enabling nodes tasked with replaying portions of the WALs to obtain leases to relevant tablets. Processes for managing granting leases to achieve consensus within distributed databases in accordance with embodiments of the invention are discussed further below.

Managing Leases

Large-scale distributed systems often require scalable and fault-tolerant mechanisms to coordinate exclusive access to shared resources such as a database table. The best known algorithms that implement distributed mutual exclusion with leases, such as Multipaxos, are complex, can be difficult to implement, and rely on stable storage to persist lease information. Systems for coordinating exclusive access to shared resources typically have the same basic structure: processes compete for exclusive access to a set of resources. Once a process has gained the right to exclusive access, it holds a lock on the resource and is called the owner of the resource. The problem of guaranteeing exclusive access in such systems can be broken down into two sub-problems:

1. Revocation. If the process owning a resource crashes or is disconnected, ownership of the resource is ideally revoked and assigned to another process;

2. Agreement. All processes ideally will agree that a specific single process is the owner of a resource.

The revocation sub-problem can be solved by leases. A lease is a token that grants access to a resource for a predefined (or dynamic) period of time. Its timeout acts as an implicit revocation mechanism. The resource becomes available again as soon as the lease times out, regardless of whether the owner has crashed, has been disconnected or has simply ceased responding in a timely way.

Agreement, the second sub-problem, can be solved for leases as well: at any point in time there may exist at most one valid lease for a resource in the system. This agreement can be formulated as a distributed consensus problem. The term “consensus” refers to the process for agreeing on one result among a group of participants. This problem becomes difficult when the participants or their communication medium can experience failures. The FLEASE process described in B. Kolbeck, M. Högqvist, J. Stender, F. Hupfeld. “Flease—Lease Coordination without a Lock Server”. 25th IEEE International Parallel & Distributed Processing Symposium (IPDPS 2011), the disclosure of which is incorporated herein by reference in its entirety, relies upon a round-based register abstraction derived from Paxos. Paxos is a well-known family of protocols for solving consensus in a network of unreliable processors. By using the round-based register, FLEASE inherits the fault tolerance of Paxos: it reaches agreement as long as a majority of processes responds and it can deal with host failures and message loss as well as reordering and delays. In contrast to Paxos, however, FLEASE takes advantage of lease timeouts to avoid persisting state to table storage. Diskless operation means that FLEASE can coordinate leases in a decentralized manner. The basic FLEASE algorithm is described below as its use in the rapid failure recovery of tablets using WALs in accordance with embodiments of the invention.

Using FLEASE to Perform Rapid Failure Recovery

Several issues exist with the use of protocols like Paxos to perform failure recovery in a distributed database that stores data in SSDs. The Paxos process works in two phases in which a proposer exchanges messages with all other processes in the system. During each phase, all processes have to write their state to table storage. The requirement of persistent storage adds extra latency to the system, which can be significant and the potential issues related to power consumption and/or useful lifetime reduction associated with excessive page-write to the SSDs. In several embodiments of the invention, a consistent distributed consensus process is utilized such as (but not limited to) a process based on FLEASE that does not involve storing leases to persistent storage. In this process, independent groups can compete for a shared resource and the leases are maintained at a central lock server. In several embodiments, a central lock service is utilized such as (but not limited to) an Apache Zookeeper ensemble to maintain leases. Where a central lock server is utilized, failure of the central lock service involves falling back to a GOSSIP process to achieve consensus. In other embodiments, a completely distributed consensus process can be utilized that does not involve a central lock server. However, such processes can involve a significantly larger volume of message passing to achieve consensus.

The main building block of FLEASE is a round-based register. The register has the same properties as Paxos regarding process failures and message loss but assumes a crash-stop behavior of processes as it lacks persistent storage. The distributed round-based register implements a shared read-modify-write variable in a distributed system. The register arbitrates concurrent accesses. Similar to Paxos, processes in FLEASE can have two roles. Proposers actively try to acquire a lease or attempt to find out which process holds a lease. Acceptors are passive, receiving read and write messages of the round-based register. The basic FLEASE process is outlined in the pseudo-code illustrated in FIGS. 9A and 9B.

In the context of the failure of a node within a distributed data system, multiple nodes within a system can store replicas of a tablet within persistent storage and can vie for access to the tablet using FLEASE. Once a lease is established, the lease can be communicated to the central lock server. A central lock server can store some lease information ephemerally. Therefore, leases can be lost in the event of the failure of a central lock server. In which case, a GOSSIP process can be utilized involving message exchange between nodes directly to obtain consensus. In the event that a node that is holding a lease with respect to one or more tablets fails, then other nodes within the group that store replicas of the tablet committed to the SSD of the failed node can contend for leases to the tablet in accordance with the FLEASE process and the WAL of the failed node used to rebuilt the tablet. As noted above, using FLEASE can significantly increase the speed of failure recovery as can splitting responsibility for rebuilding a tablet across multiple nodes by performing distributed log splitting using a centralized lock server.

Failure Recovery Using Distributed Log Splitting and Distributed Consensus

The distributed log splitting and consensus processes described above can be utilized to reduce the time to recover from node failures in a distributed database in accordance with an embodiment of the invention. A process for performing rapid recovery in response to node failure in accordance with an embodiment of the invention is illustrated in FIG. 9C. The process 900 commences with node failure (902). When ephemeral data is not lost, then rapid failure recovery occurs when a node that stores a replica of a tablet served by a failed region many-core processor server obtains a lease to the tablet using a distributed consensus protocol and reports the lease to a central lock server. While the distributed consensus protocols discussed herein are particularly efficient during failure recovery, any of a variety of consensus protocols can be utilized in accordance with embodiments of the invention.

When a determination (904) is made that ephemeral data is lost as a result of a node failure, then the central lock server can be utilized to coordinate the distributed WAL splitting (906) of the failed nodes. Portions of the WALs can be assigned (908) to nodes that have replicas of tablets served by failed nodes. The node that store replicas of tablets served by failed region many-core processor servers can then obtain leases (910) to modify the tablets using a distributed consensus protocol utilizing the central lock server. Once the leases are obtained, the portions of the WAL can be replayed (912). In a number of embodiments, the time to failure recovery can be further reduced by performing distributed splitting of the impacted tablets in addition to distributed splits of the impacted WALs. In this way, greater parallelization can be achieved.

Although specific processes for rapid write ahead log fail over are described above with respect to FIG. 9A and FIG. 9B, any of a variety of processes for rapidly recovering from node failure using the WALs of failed nodes can be utilized as appropriate to the requirements of specific applications in accordance with embodiments of the invention. Querying of distributed databases in accordance with embodiments of the invention is discussed further below.

Querying Distributed Databases Utilizing Many-Core Processors

Many-core processors include multiple processing cores that incorporate a high performance mesh that can achieve extremely high data throughput. In many embodiments, the distributed database system parses a query into one or more Kahn Processing Network (KPN) tokens that can be mapped to the processing cores within various nodes within a distributed database. KPNs are thought to be the least restrictive message-passing model that yields provably deterministic programs (i.e. programs that yield always the same output given the same input, regardless of the order in which individual processes are scheduled). KPNs, and the use of KPNs to execute queries on many-core processors in accordance with embodiments of the invention, are discussed below.

Kahn Processing Networks

A KPN has a simple representation in the form of a directed graph with processes as nodes and communication channels at edges. Therefore, the structure of a KPN corresponds well with the processing tiles and high performance mesh within a many-core processor. In the context of a KPN, a process encapsulates data and a single, sequential control flow, independent of any other process. Processes are not allowed to share data and may communicate only by sending messages over channels. Channels are infinite FIFO queues that store discrete messages. Channels have exactly one sender and receiver process on each end (1:1), and every process can have multiple input and output channels. Sending a message to the channel always succeeds, but trying to receive a message from an empty channel blocks the process until a message becomes available. It is typically not allowed within a KPN to poll a channel for the presence of data.

In KPNs, the lack of constraints on process behavior and the assumption that channels have infinite capacities can result in the construction of KPNs that need unbounded resources for their execution. A many-core processor is memory constrained, therefore, a KPN can more readily map to a many-core processor by assigning capacities to channels and redefining the semantics of the send process within a KPN to block a sending process if the delivery would cause the channel to exceed its capacity. Under such send semantics, an artificial deadlock may occur (i.e. a situation where a cyclically dependent subset of processes blocks on send, but which would continue running in the theoretical model). Artificial deadlocks can be resolved by traversing the cycle to find the channel of least capacity and enlarging it by one message, thus resolving the deadlock. Because the bandwidth within a many-core processor is effectively infinite, additional buffering that what would normally be allowed in a FPGA/highly limited environment can be done.

Using KPNs for execution of parallel applications can provide the following benefits:
a) Sequential coding of individual processes. Processes are written in the usual sequential manner; synchronization is implicit in explicitly coded communication primitives.
b) Composability. Connecting the output of a network computing function ƒ(x) to the input of a network computing g(x) guarantees that the result will be (g(ƒ(x)). Thus, components can be developed and tested individually, and later assembled together to achieve more complex tasks.
c) Reliable reproduction of faults. Because KPNs are a deterministic model for distributed computation, it is possible to reliably reproduce faults (otherwise notoriously difficult), which will greatly ease debugging.

While many of the above benefits of KPNs are shared by MapReduce, KPNs have several additional properties that can make them suitable for modeling and implementing a wider range of problems than MapReduce and Dryad:
a) Arbitrary communication graphs. Whereas MapReduce and Dryad restrict developers to the structure of FIG. 1 and directed acyclic graphs (DAGs), respectively, KPNs allow cycles in the graphs. Because of this, they can directly model iterative algorithms. With MapReduce and Dryad this is only possible by manual iteration, which incurs high setup costs before each iteration.
b) No prescribed programming model. Unlike MapReduce, KPNs do not require that the problem be modeled in terms of processing over key-value pairs. Consequently transforming a sequential algorithm into a Kahn process often involves minimal modifications, consisting mostly of inserting communication statements at appropriate places.

Executing Database Queries Using Kahn Processing Networks

As noted above, KPNs map well to the physical structure of a many-core processor. In several embodiments, a distributed database in accordance with embodiments of the invention maps queries in a query language such as, but not limited to, SQL to a physical KPN that can be scheduled and executed on one or more many-core processor servers.

A process for executing a database query by parsing the database query to create a Kahn Processing Network in accordance with an embodiment of the invention is illustrated in FIG. 10. The process 1000 includes receiving (1002) a string in a structured query language such as, but not limited to, SQL (ISO/IEC 9075). A variety of techniques are known for developing a query plan based upon a query expressed using a structured query language. In the illustrated embodiment, the query is parsed to create (1004) a query tree. A query tree stores the separate parts of a query in a hierarchical tree structure. In several embodiments, a query optimizer takes the query tree as an input and attempts to identify (1006) an equivalent query tree that is more efficient. Query optimizers for structured query languages are well known including (but not limited) cost-based query optimizers that assign an estimated “cost” to each possible query tree, and choose the query tree with the smallest cost. Costs can be used to estimate the runtime cost of evaluating the query, in terms of the number of I/O operations required, the processing requirements, and other factors. In a number of embodiments, optimizations are left for later in the process. In many embodiments, the selects and joins in a query can be optimized for the generation of a KPN so that rows are selected and flow through to other processes in the parse tree.

In several embodiments, a set of mappings is defined that maps specific nodes within a query tree to a KPN. In many embodiments, a process determines portions of the query tree that can execute simultaneously. The parts that can be independent in parallel can then be transformed (1008) to processes within a KPN using the mappings. The result of the transformation is a raw KPN. The resources utilized to execute a query can be reduced by optimizing (1010) the KPN. In several embodiments, a variety of rule based and/or cost based optimizations can be performed with respect to the KPN using techniques similar to those used to optimize query plans. The result of the optimization is a semi-abstract KPN that may not correspond well with the physical structure of a many-core processor. Accordingly, a description of the cores and location of data within a distributed database can be utilized to place and route (1012) the processes and communication channels within the KPN to create a physical KPN plan where processes are assigned to individual cores within one or more many-core processors. The processes and the communication channels within the KPN can then be used to schedule and (1014) execute the query on the processing cores within the distributed database to return (1016) the relevant query results.

Although specific processes are described above with respect to generating KPNs to query a distributed database based upon queries provided in a structured query language, any of a variety of techniques can be utilized to execute a query within a distributed database using a KPN in accordance with embodiments of the invention. The execution of queries using specific types of indexes incorporated within distributed databases in accordance with embodiments of the invention is discussed further below.

Accessing Data Using Additional Indexes

Data can be accessed using the basic indexes that built during the storage of rows in tablets within a distributed database in accordance with embodiments of the invention. In many embodiments, additional indexes are provided to enable the more rapid and/or lower power execution of specific types of queries. In a number of embodiments, individual nodes within the distributed database include a keyword index that indexes strings of text within one or more columns of a tablet maintained by the node enabling the rapid retrieval of rows of data relevant to specific keyword queries. In several embodiments, the distributed database utilizes a spatial index to assist with the rapid retrieval of data. In other embodiments, any index appropriate to the requirements of a specific application can be utilized. Various indexes that can be utilized within distributed databases in accordance with embodiments of the invention are discussed further below.

Full Text Searching

Distributed databases in accordance with embodiments of the invention can include columns containing unstructured data such as text. In many embodiments, a keyword index is utilized to provide full text search capabilities with respect to text strings within one or more columns of a tablet. In several embodiments, a full text search index constructed using a search engine is utilized to generate a keyword index and to rank the relevancy of specific rows with respect to specific keywords using techniques including but not limited to keyword frequency/inverse document frequency. In the preferred embodiment, the high-performance, full featured text search engine library utilized is called Apache Lucene. Indexes generated by Apache Lucene and/or using a similar search engine indexing technology can be utilized for querying specific strings within tablets served by a server. In other embodiments, any of a variety of search engines can be utilized to provide full text search capabilities within a distributed database in accordance with embodiments of the invention including, but not limited to, search engines that also employ a Vector Space Model of search.

Multi-Dimensional Indexes

Data such as location data is inherently multi-dimensional, minimally including a user id, a latitude, a longitude, and a time stamp. Key-value stores, similar to those utilized in the distributed databases described above, have been successfully scaled in systems that can handle millions of updates while being fault-tolerant and highly available. However, key-value stores do not natively support multi-dimensional accesses without scanning entire tables. A full scan of a table can be unnecessary wasteful, particularly in low power applications. In many embodiments, a multi-dimensional index is layered on top of a key-value store within a distributed database, which can be (but is not limited to being) implemented using LSM-trees in the manner outlined above. In several embodiments, the multi-dimensional index is created by using linearization to map multiple dimensions to a single key-value that is used to create an ordered table that can then be broken into tablets and distributed throughout the distributed database. In several embodiments, the multi-dimensional index divides the linearized space into subspaces that contain roughly the same number of points and can be organized into a tree to allow for efficient real-time processing of multi-dimensional range and nearest neighbor queries.

In several embodiments, linearization is utilized to transform multi-dimensional data values to a single dimension. Linearization allows leveraging a single-dimensional database (a key-value store) for efficient multi-dimensional query processing. A space-filling curve is one of the most popular approaches for linearization. A space-filling curve visits all points in the multi-dimensional space in a systematic order. Z-ordering is an example of a space-filling curve that loosely preserves the locality of data-points in the multi-dimensional space and is also easy to implement. In other embodiments, any of a variety of linearization techniques and space-filling curves can be utilized as appropriate to the requirements of specific applications.

Linearization alone, however, may not yield efficient query processing. Accordingly, multi-dimensional index structures have been developed that split a multi-dimensional space recursively into subspaces in a systematic manner and organize these subspaces as a search tree. Examples of multi-dimensional index structures include (but are not limited to) a Quad tree, which divides the n-dimensional search space into 2ⁿ subspaces along all dimensions and a K-d tree that can alternate the splitting of the dimensions. Each subspace has a maximum limit on the number of data points in it, beyond which the subspace is split. Approaches that can be utilized to split a subspace include (but are not limited to) a trie-based approach, and a point-based approach. The trie-based approach splits the space at the mid-point of a dimension, resulting in equal size splits; while the point-based technique splits the space by the median of data points, resulting in subspaces with equal number of data points. The trie-based approach is efficient to implement as it results in regular shaped subspaces. In addition to the performance issues, trie-based Quad trees and K-d trees have a property that allows them to be coupled with Z-ordering. A trie-based split of a Quad tree or a K-d tree results in subspaces where all Z-values in any subspace are continuous. Quad trees and K-d trees can be adapted to be layered on top of a key-value store. The indexing layer assumes that the underlying data storage layer stores the items sorted by their key and range-partitions the key space, where the keys correspond to the Z-value of the dimensions being indexed.

A multi-dimensional index can enable rows of a table to be sorted with respect to the ranges of n key-values instead of a single key value. In this way, the data is structured so that queries over the n-dimensions are likely to involve the need to send messages to fewer nodes within the distributed database, and the need to access fewer pages. This reduction in messaging and page accesses relative to data stored using a single key value index can significantly reduce the power consumption of the distributed database.

While n-dimensional indexing has been described above, other forms of linear indexing can be utilized in the present invention, whereby each index table provides a linear/single key index. This can provide fast cluster look-up of small secondary key queries in order to write to a secondary index table, arranged by the rowid/key, because the rowid/key of the secondary table is the indexed value.

The use of multi-dimensional indexes has typically been thought to present problems with respect to adding dimensions to tables. In a number of embodiments of the invention, the addition of columns is achieved by creating a separate pocket index. As inserts are performed within blocks within the system, a pocket index is created and splits are performed in the background. Once the splitting is completed, the side index can be flushed into the multi-dimensional index system.

A process for performing splits in a spatial index within a distributed database in accordance with embodiments of the invention is illustrated in FIG. 11. The process 1100 includes receiving (1102) an instruction to add a dimension to a table. The process stops permitting inserts to the table and then adds the additional dimension (column) to the table. In adding the new column, the multi-dimensional index is rebuilt by generating (1106) new key-value pairs through a linearization process appropriate to the requirements of a specific application. A table sorted by key-value range can be generated and split (1108) into subspaces in the manner outlined above to create a new table partitioned into tablets in accordance with key-value ranges. During the time that the dimension is added and the splits are being performed to create the new tablets, requests to insert rows into the table may be received (1110) by the distributed database. The inserted rows can be cached (either in memory and/or flushed into SSDs) and a pocket index can be generated (1112) with respect to the rows that are being cached. When a determination (1114) is made that the split is complete, the rows can be added to the partitioned table and the pocket index can be flushed (1116) into the multi-dimensional index. At which point, the dimension(s) has been successfully added to the table and normal operation of the distributed database can resume.

Although specific processes for modifying the dimensionality of multidimensional tables in accordance with embodiments of the invention are described above with reference to FIG. 11, any of a variety of multi-dimensional indexes can be overlaid on the key-value store maintained by a distributed database as appropriate to the requirements of a specific application in accordance with embodiments of the invention.

FIG. 12 discloses a top level transaction story which can be utilized by the present invention. The top level transaction story can provide replication of data across nodes, which combines write-ahead-logs for multiple nodes for purposes of log splitting or distributed splitting. This embodiment uses certain concepts from Jun Rao, Eugene Shekita, Sandeep Tata—“Using Paxos to Build a Scalable, Consistent, and Highly Available Datastore,” Proceedings of the VLDB Endowment, Vol. 4, No. 4 (2011), which is incorporated by reference as if fully set forth herein. The illustrated embodiment also uses aspects of flease, as described by Kolbeck et al. Messages flow from 2PC 1201 to tablet replica sets 1202, 1203 for R[1] and R[2]. For each tablet replica set R[1] 1202 and R[2] 1203, Replica 1 (indicated by 1202a, 1203a) can be created using flease, and Replica 2 (indicated by 1202b, 1203b) can be formed by a centralized naming service. Replica 3 (indicated by 1202c, 1203c) can be created through the use of one or more Paxos messages, which are the messages outlined in FIG. 9A that are formatted to convey the information necessary to carry out the algorithm. Each replica set learns they are part of the same replica (e.g., 1202a, 1202b, & 1202c) and communicates with each other on a network port (e.g., TCP/UDP port number). The present invention allows the replicas to initialize communications and exchange messages using the algorithm outlined in FIG. 9A. In the preferred embodiment, three Replicas are utilized for each replica set. However, a higher number of Replicas is envisioned by the present invention as well, so long as such number can be achieved by the 2F+1 algorithm. Using this algorithm, the number of failures looking to be prevented will indicate the number of Replicas required in each replica set.

The resulting process is tolerant of 2F+1 failures and prevents a dead coordinator from stalling a 2PC transaction. Replica sets ensure that any given piece of data (e.g.: a single row) is replicated across multiple machines to protect against machine failure. To accomplish multi-row (aka: multi-replica sets) atomic writes (aka: transactions), we use the 2 phase commit algorithm (2PC). 2PC has a particular failure mode where the failure of the coordinator node causes failure of the transaction. So by using flease to detect coordinator/leader failure, and by using fail over inside the replicas 1202, 1203, we can prevent this failure mode. To be specific, if leader Replica 1202a fails, then one of the other replicas, such as 1202b will take over, and having the full knowledge of what 1202a knew (since as 1202a takes actions it sends that information via the Spinnaker algorithm discussed by Jun et al. to the other replicas), it can take over for 1202a and the transaction can proceed.

Although the present invention has been described in certain specific aspects, many additional modifications and variations would be apparent to those skilled in the art. It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What we claim:

1. A distributed database, comprising:
a plurality of server racks;
one or more many-core processor servers in each of said plurality of server racks;
wherein each of said one or more many-core processor servers comprises a many-core processor, said many-core processor configured to store and access data on one or more solid state drives in the distributed database, said one or more solid state drives configured to enable retrieval of said data through one or more text-searchable indexes;
wherein said one or more many-core processor servers are configured to communicate within said plurality of server racks via a network; and
wherein said data is configured as one or more tables distributed to said one or more many-core processor servers for storage in said one or more solid state drives.
